(19) United States
(12) Patent Application Publication
(10) Pub. No.: US 2009/0223074 A1
(43) Pub. Date: Sep. 10, 2009

(54) GAGE FOR MEASURING DISC BRAKE THICKNESS

(76) Inventor: Lin WO, Nanjing City (CN)

Correspondence Address: STANDLEY LAW GROUP LLP, 6300 Riverside Drive, Dublin, OH, 43017, US

(21) Appl. No.: 12/400,397

(22) Filed: Mar. 9, 2009

Related U.S. Application Data
(60) Provisional application No. 61/034,650, filed on Mar. 7, 2008.

(51) Int. Cl. G01B 1/00

(52) U.S. Cl. 33/610

(57) ABSTRACT

A device for measuring a thickness of a disc brake has a frame with a pair of spaced-apart clovis arms. A fixed first anvil is arranged in the first of the clovis arms, with a tip of the anvil directed inwardly towards a tip of a opposing, co-axial second anvil. The second anvil is mounted for sliding motion in a bore in the second of the clovis arms. The second anvil has a meter for displaying an axial translation measurement disposed on it, outside of the clovis arm. The meter is in communication with a device for measuring the axial translation, such as a vernier. A lift device on the second anvil may be provided to facilitation fine control of the axial translation. Preferably, a biaser urges the second anvil towards the first anvil, and a delimiter of this biasing urge may be provided.

### CROSS-REFERENCE TO RELATED APPLICATIONS

This application is a non-provisional of, and makes claim of the benefit of priority to, U.S. provisional patent application Ser. No. 61/034,650, filed 7 Mar. 2008, which is incorporated by reference as if fully recited herein.

### TECHNICAL FIELD

This application relates to the field of gages, particularly, to the field of gages for measuring the thickness of a disc brake. Even more particularly, it relates to a device and method for measuring the minimum thickness of a disc brake.

### BACKGROUND OF THE ART

In the field of maintaining disc brakes, it is important and known to measure certain aspects of a disc brake to a high degree of accuracy and precision. One measurement that is required is a determination of the minimum thickness of the disc brake.

In particular, when referring to the minimum thickness of the disc brake, it is the brake pad, a sacrificial member, to which this application refers. While it is desirable that a disc brake have a consistent value of the minimum thickness as one moves around the circumference, actual observation is that the thickness may vary, in both the circumferential and the radial direction.

At least two problems exist in the known prior art gages for measuring disc brake thickness. First, many known gages provide a first, flat tipped spindle and a second spindle with a pointed tip. The purpose is to assure that the respective spindles are each in normal position relative to the respective disc brake surfaces, with the flat tipped spindle providing the required alignment, through its shape. However, the flat tip will generally be unable to fit into any groove in the surface, as the groove will be smaller than the surface dimensions of the flat tip. Second, even if the point of minimum thickness is located, the known gages make the act of obtaining accurate results and simultaneously recording these results in a useful manner a difficult task.

Therefore, it is an unmet objective of the prior art as known to provide a gage for both accurately and precisely measuring the minimum thickness of a disc brake.

### SUMMARY OF THE INVENTION

This and other objectives are achieved by a gage for measuring the minimum thickness of a disc brake.

In an exemplary embodiment, the device comprises a frame with a pair of spaced-apart clovis arms. First and second anvils are positioned in the respective arms of the clovis, with the first anvil arranged in fixed position, but with the second anvil mounted for sliding motion in a bore in the second clovis arm. The anvils are directed towards the interior of the clovis, in a co-axial facing relationship, the second anvil movable along the axis. A means, such as a vernier, is provided to measure axial translation of the second anvil in the bore. By communicating an output of this axial translation measurement means to a readout device, such as a meter positioned on the second anvil, a user is able to monitor the measurement. A lift device on the second anvil allows fine control of the translation of the anvil in the bore.

In most aspects, it will be advantageous to provide the facing tips of the anvils with pointed ends.

In most aspects, it will also be advantageous to provide a means for biasing the second anvil in the bore. This biasing means acts to urge the tip on the second anvil toward the tip of the first anvil. Where the biasing means is provided, it will be preferred to also provide a delimiter to the biasing force, such the engagement of the readout device against the clovis arm.

### BRIEF DESCRIPTION OF THE DRAWINGS

A better understanding of the invention will be had by reference to the accompanying FIGURE, wherein identical parts are identified by identical part numbers and wherein:

FIG. 1 is a front elevation view of an embodiment of a disc brake gage, in isolation.

### DETAILED DESCRIPTION OF THE DRAWINGS

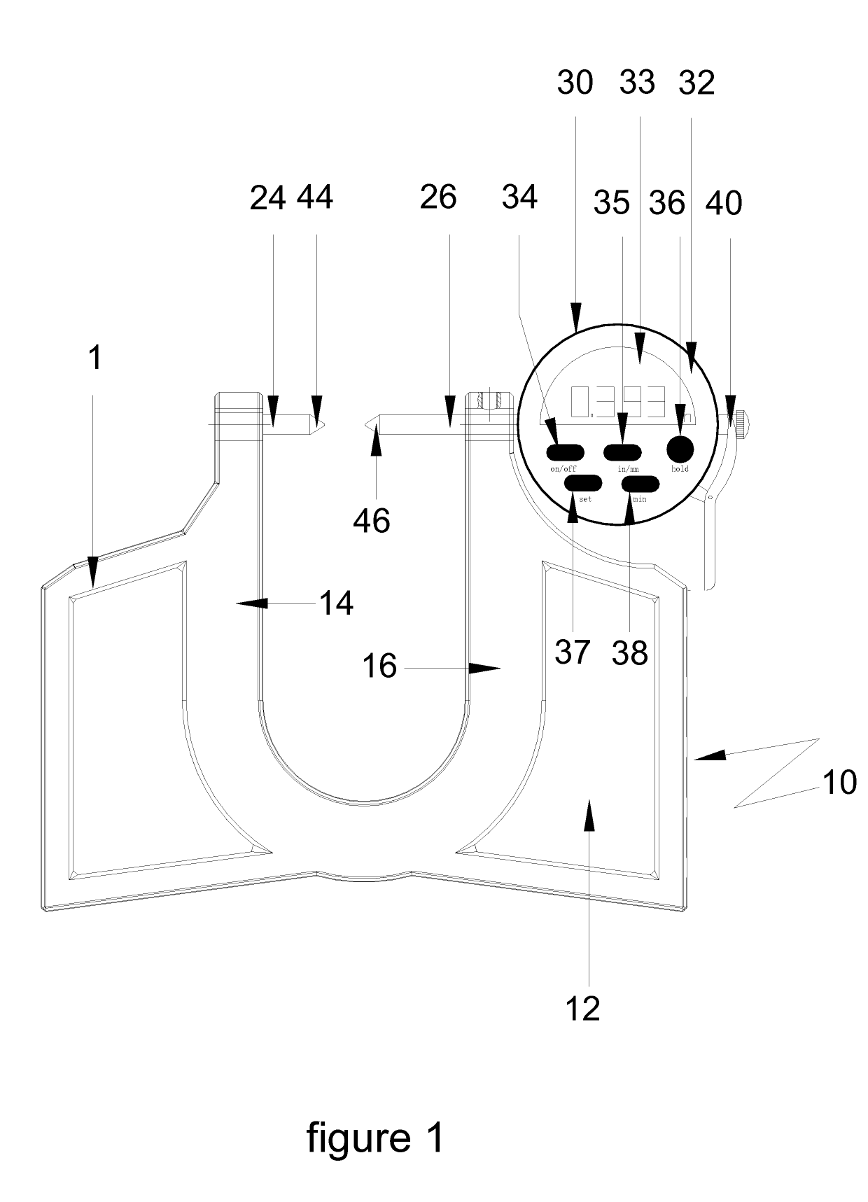

Referring to FIG. 1, an embodiment of a digital disc brake gage 10 is seen in front elevation view. The gage comprises a frame 12 with a pair of spaced-apart clovis arms 14, 16. A first anvil 24 is arranged in fixed position in clovis arm 14, and a second anvil 26 is mounted in the second clovis arm 16. Anvils 24, 26 are positioned relative to each other in a co-axial facing manner, with second anvil 26 movable along the axis. A readout device 30 is positioned on second anvil 26. A lift device 40 is also positioned on second anvil 26.

In the embodiment shown, the facing tips 44, 46 of anvils 24, 26 are pointed, so as to be able to reach into any grooves encountered on the surface of a disc brake being measured. In other embodiments, each end may be provided with a rounded surface of small diameter, such as would be encountered on a fine point roller-ball pen. This latter design allows entry into small grooves, while also allowing lateral movement across the surface.

Typically, as is known in this art, second anvil 26 is maintained in a bore through second clovis arm 16 by a biasing means that urges the anvil tip inwardly of the clovis, that is, in the direction of tip 44 on the first anvil 24.

The readout device 30 is connected to the second anvil 26. Readout device 30 may provide a stop means, delimiting the inward movement of the anvil that is urged by the biasing means, although another delimiting means may be provided and used.

The readout device 30 will be provided with a display face 32. Prominent on the display face 32 is a display area 33, which will be filled by a display means, typically a liquid crystal diode (LCD). Various control buttons are depicted. Among these are an “on/off” function button 34, a units selection button 35, a “hold” button 36, a “set” button 37 and a “min” button 38. Of particular note is the “min” button 38. Internal to the readout device 30 is a digital chip for operating the readout device 30, as well as a power source, typically a small battery. Integral to the digital chip is a logic circuit that allows a minimum measured distance value to be stored in a memory register. Use of the “min” button 38 causes the value stored in the memory register to be displayed.

It will be readily known to those of skill in this art to properly connect the digital chip in the readout device 30 to known means in the bore, so that movement of the second anvil in the bore is accurately and precisely measured.

By placing the disc brake to be measured within the clovis while lifting the second anvil 26 by use of the lift device 40 and then allowing the respective anvil tips 44, 46 to come into contact with the opposing surfaces of the disc brake, an initial reading of the thickness may be obtained.

With the device 10 so positioned, the digital chip of the readout member 30 powered up and the minimum value register either “zeroed” or set to a value that is clearly larger than the diameter, device 10 may be moved around the disc brake surface, constantly making thickness measurements. Keeping in mind that the shortest distance between any two points on the opposing faces is a normal line between the surfaces, and that by keeping the tips 44, 46 in contact with the surfaces, slight lateral movement of the tips will seek out the true minimum thickness over the portion of the disc which is scanned with the device. This value will be recorded as the minimum value.

What is claimed is:

1. A device for measuring a thickness of a disc brake, comprising:
a frame with a pair of spaced-apart clovis arms;
a first anvil arranged in fixed position in a first of the clovis arms;
a second anvil is mounted for sliding motion in a bore in the second of the clovis arms, the anvils positioned relative to each other in a co-axial facing manner, with the second anvil movable along the axis;
means for measuring axial translation of the second anvil in the bore
a readout device, positioned on the second anvil and communicated to the translational measuring means; and
a lift device, positioned on the second anvil.

2. The device of claim 1, further comprising:
first and second tips, provided on the facing ends of the respective anvils.

3. The device of claim 2, wherein:
the tips are pointed.

4. The device of claim 1, further comprising:
a means for biasing the second anvil in the bore, the biasing means acting to urge the tip on the second anvil toward the tip of the first anvil.

5. The device of claim 4, wherein:
the position of the readout device delimits the inward movement of the second anvil that is urged by the biasing means.

6. The device of claim 1, further comprising:
a display face on the readout device.

7. The device of claim 1, wherein:
the translational measuring means is a vernier.

8. The device of claim 1, wherein:
the lift device is a finger handle that allows fine control translation of the second anvil in the bore.
